(19) United States
(12) Patent Application Publication
(10) Pub. No.: US 2005/0258980 A1
(43) Pub. Date: Nov. 24, 2005

(54) System and method for notification of arrival of bus or other vehicle

(75) Inventor: Joseph J. Conover, Carmel, IN (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 10/848,965

(22) Filed: May 19, 2004

(51) Int. Cl. G08G 1/123

(52) U.S. Cl. 340/994; 340/539.1

(57) ABSTRACT

A system and method for detecting the proximity of a bus or other transportation. Each bus is equipped with a transmitter, typically radio-frequency (RF), that broadcasts as the bus travels. As the bus and transmitter come within range of corresponding receivers, the receivers will detect the transmitter and will indicate that the bus is approaching. The receivers can be placed at the bus stop, and can also be carried by passengers so that they can be notified of the approaching bus before actually having to go to the bus stop. In various embodiments, the transmitters are implemented using radio-frequency identification (RFID) tags, Bluetooth, and other known RF technologies. Preferably, the transmitters will transmit an identifier that indicates the bus route or specific bus, and the receivers are programmed to only indicate the presence of selected buses.

### TECHNICAL FIELD OF THE INVENTION

The present invention is directed, in general, to bus arrival notification systems.

### BACKGROUND OF THE INVENTION

One common experience, in all parts of the world, is waiting on public transportation to arrive, and particularly common is the experience of waiting on a late bus. Unfortunately, buses and other public transportation often are behind schedule. Often the passenger could wait inside a house or other more-comfortable location if he knew when the bus would arrive, but is forced to stand outside at the bus stop because he cannot determine when the bus will arrive, and can't risk missing the bus.

In some cases, global positioning satellite (GPS) systems are used to track the current location of buses, and the current location information is used to display an estimated time of arrival at selected bus stops. While this is an improvement over traditional systems, this requires dedicated, expensive equipment, and still requires that the passenger actually check the time at the bus stop, with way of checking timeliness before going to the bus stop.

There is, therefore, a need in the art for a system and method for detecting the arrival of a bus, other public transportation, or similar.

### SUMMARY OF THE INVENTION

A preferred embodiment provides a system and method for detecting the proximity of a bus or other transportation. Each bus is equipped with a transmitter, typically radio-frequency (RF), that broadcasts as the bus travels. As the bus and transmitter come within range of corresponding receivers, the receivers will detect the transmitter and will indicate that the bus is approaching. The receivers can be placed at the bus stop, and can also be carried by passengers so that they can be notified of the approaching bus before actually having to go to the bus stop. In various embodiments, the transmitters are implemented using radio-frequency identification (RFID) tags, Bluetooth, and other known RF technologies. Preferably, the transmitters will transmit an identifier that indicates the bus route or specific bus, and the receivers are programmed to only indicate the presence of selected buses.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts an exemplary embodiment of the present invention;

FIG. 2 depicts a second exemplary embodiment of the present invention;

FIG. 3 depicts a flowchart of a process in accordance with a preferred embodiment.

### DETAILED DESCRIPTION OF THE INVENTION

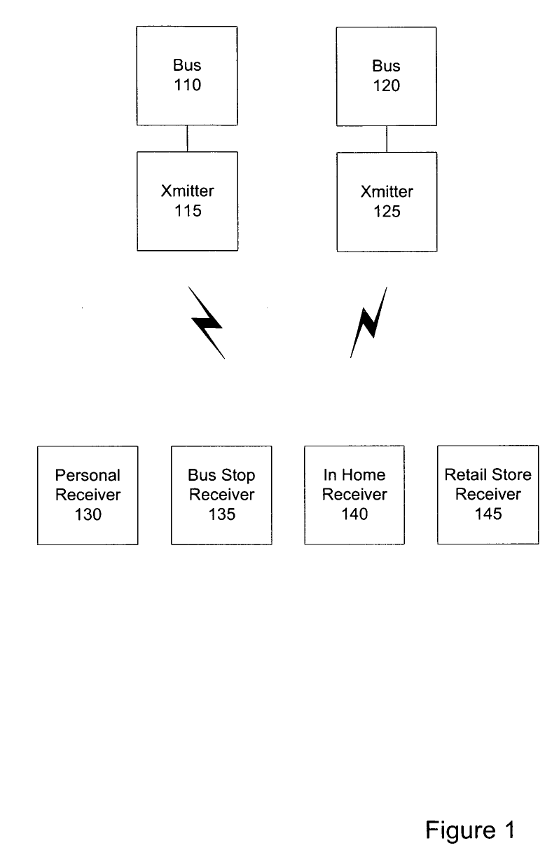

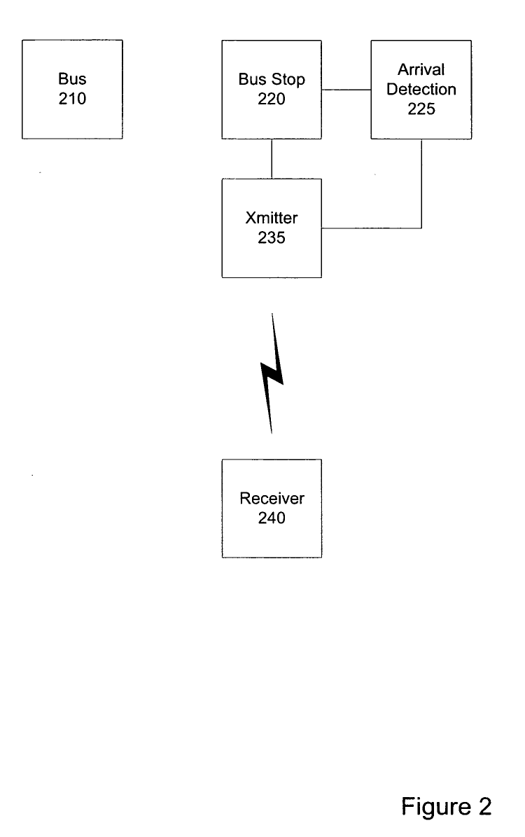

FIGS. 1 and 2, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

A preferred embodiment provides a system and method for detecting the proximity of a bus or other transportation. Each bus is equipped with a transmitter, typically radio-frequency (RF), that broadcasts as the bus travels. As the bus and transmitter come within range of corresponding receivers, the receivers will detect the transmitter and will indicate that the bus is approaching. The receivers can be placed at the bus stop, and can also be carried by passengers so that they can be notified of the approaching bus before actually having to go to the bus stop. In various embodiments, the transmitters are implemented using transmitter/receiver pairs with ranges of up to several miles, and are well known in the art. Preferably, the transmitters will transmit an identifier that indicates the bus route or specific bus, and the receivers are programmed to only indicate the presence of selected buses.

While most of the description herein will refer only to public-transportation buses, for sake of simplicity, those of skill in the art will recognize that the principles of the disclosed embodiments apply to many types of vehicles, such as (but not limited to) a school bus, vehicle, taxi, subway train, mail carrier, garbage truck, or other public transportation or vehicle for which a proximity warning would be useful.

FIG. 1 depicts a simplified illustration of an exemplary implementation. Here, bus 110 is equipped with transmitter 115, and bus 120 is equipped with transmitter 125. Several receivers are shown here, such as personal receiver 130, bus-stop receiver 135, in-home receiver 140, and retail-store receiver 145.

Depending on this implementation, all receivers can be programmed to respond to all transmitters. In this example, assume that receivers 130 and 140 are programmed to respond to transmitter 115, and receivers 135 and 145 are programmed to respond to transmitter 125, using known techniques including Bluetooth, RFID, other digital “signature”, by broadcasting on a specific frequency, or by broadcasting a tone on a frequency.

In this case, as bus 110 travels, transmitter 115 preferably broadcasts a continual signal including an identifier. As it comes into proximity of each receiver, and that range will vary depending on the RF technology used, each receiver will detect the transmitter's presence, and determine the if the transmitter is one to which it should respond. Receivers 130 and 140, upon detection of transmitter 115, will signal the proximity of bus 110, by sound, light, vibration, or a combination of these or other known method. Receivers 135 and 145, on the other hand, typically can detect transmitter 115, but will not respond to it.

Personal receiver 130 is preferably small and portable, so that it can be carried in a pocket, clipped to clothing, a purse, or a backpack, and otherwise convenient and easy for a person to carry with them.

Preferably, the range of a transmitter/receiver combination is such that the proximity warning is given while the bus is still approximately two to three minutes away from the receiver, to give the passenger time to go to the bus stop or other pickup location.

FIG. 2 illustrates another exemplary implementation in accordance with a preferred embodiment. In this case, a proximity transmitter/receiver combination is used in conjunction with a known GPS-type bus arrival predictions system. Here, bus 210 is equipped with a GPS location system, as known in the art. This GPS location system includes a location unit attached to a vehicle, the location unit including a global-positioning-satellite receiver and a location transmitter for transmitting the location of the vehicle as determined by the global-positioning-satellite receiver. Bus stop 220 is equipped with a known arrival-prediction system 225, wherein the estimated time of arrival is calculated according to the GPS-determined current location of the bus. In a preferred embodiment, the arrival-prediction system has a vehicle arrival indicator including a location receiver for receiving the location of the vehicle from the location transmitter, calculating means for determining a time-to-arrival of the vehicle based on the location of the vehicle. Bus stop 220 also includes a transmitter 235, connected to be activated by arrival-prediction system 225, and configured to communicate with receiver 240, which can be any of the receiver types described above.

In this example, when arrival-prediction system 225 determines that bus 210 should arrive within a specified amount of time, such as two minutes, it will activate transmitter 235, which will begin broadcasting.

When receiver 240 receives this broadcast, it will indicate the proximity of bus 210 to bus stop 220. In this way, the passenger can then go to bus stop 220 in a timely fashion, without having to wait there for an excessive time.

In either embodiment above, the transmitter/receiver combination can be implemented using many known limited-range transmitter/receiver pairs. For example, common radios transmitting at 200 mW in the 460 MHz range have an approximate range of 2 miles, depending on terrain and interfering obstacles. Other common radios operate at 1W-5W in the same frequency range for an approximate range of 5-7 miles.

To identify a specific bus, the transmitter can be configured to broadcast only on a specific frequency, assigned to that bus.

Alternately, several buses (or bus stops) can use the same frequency, each transmitting a unique tone on the frequency, as known to those of skill in the art. For example, two buses might transmit on 465 MHz, one broadcasting a 67 Hz tone and the other broadcasting a 77 Hz tone. A receiver can then be programmed to only respond or “alert” to detecting a 77 Hz tone broadcast on 465 MHz.

Similarly, in a preferred embodiment, a receiver can be programmed for multiple frequency/tone pairs, so that it is programmed for multiple specific vehicles or stops.

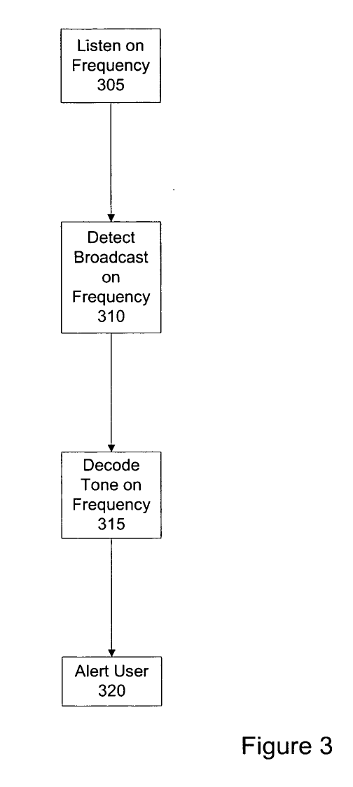

FIG. 3 depicts a flowchart of a process in accordance with a preferred embodiment, as performed by the receiver. Here, the receiver “listens” on a preselected frequency or frequencies (step 305). Next, as the vehicle approaches, the receiver will detect the broadcast signal from the vehicle's transmitter (step 310).

Next, in some embodiments, the receiver will broadcast a tone carried on the broadcast signal (step 315).

Finally, depending on the frequency of the broadcast signal detected, and optionally on the decoded tone, the receiver will alert the user to the proximity of the vehicle (Step 320).

Those skilled in the art will recognize that, for simplicity and clarity, the full structure and operation of all systems suitable for use with the present invention is not being depicted or described herein. Instead, only so much of a transmitter/receiver system as is unique to the present invention or necessary for an understanding of the present invention is depicted and described. The remainder of the construction and operation of the system may conform to any of the various current implementations and practices known in the art.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A vehicle-arrival detection system, comprising:
a transmitter attached to a vehicle, the transmitter sending a broadcast signal; and
a receiver configured to detect the broadcast signal when the receiver is within the broadcast range of the transmitter, the receiver further configured to alert a user that the broadcast signal has been detected.

2. The system of claim 1, wherein the receiver is further configured to decode a tone, the tone being carried on the broadcast signal, and wherein the receiver alerts the user that the tone has been decoded.

3. The system of claim 1, wherein the vehicle is a bus.

4. The system of claim 1, wherein the vehicle is a train.

5. The system of claim 1, wherein the receiver is located in the user's home.

6. The system of claim 1, wherein the receiver is located in a bus stop.

7. The system of claim 1, wherein the receiver is a portable receiver carried by the user.

8. A vehicle-arrival detection system, comprising:
a location unit attached to a vehicle, the location unit including a global-positioning-satellite receiver and a location transmitter for transmitting the location of the vehicle as determined by the global-positioning-satellite receiver;
a vehicle-arrival indicator, the vehicle arrival indicator including a location receiver for receiving the location of the vehicle from the location transmitter, calculating means for determining a time-to-arrival of the vehicle based on the location of the vehicle, and a transmitter for sending a broadcast signal when the time-to-arrival is below a specified threshold; and
a receiver configured to detect the broadcast signal when the receiver is within the broadcast range of the transmitter, the receiver further configured to alert a user that the broadcast signal has been detected.

9. The system of claim 8, wherein the receiver is further configured to decode a tone, the tone being carried on the broadcast signal, and wherein the receiver alerts the user that the tone has been decoded.

10. The system of claim 8, wherein the vehicle vehicle-arrival indicator further comprises a display for displaying the time-to-arrival.

11. The system of claim 8, wherein the vehicle is a bus.

12. The system of claim 8, wherein the vehicle is a train.

13. The system of claim 8, wherein the receiver is located in the user's home.

14. The system of claim 8, wherein the receiver is located in a bus stop.

15. The system of claim 8, wherein the receiver is a portable receiver carried by the user.

16. A method for detecting the arrival of a vehicle, comprising:
detecting, by a receiver, a signal broadcast from a transmitter attached to a vehicle when the receiver is within broadcast range of the transmitter; and
alerting a user that the broadcast signal has been detected.

17. The method of claim 16, further comprising decoding a tone carried on the broadcast signal, and alerting the user that the tone has been decoded.

18. The method of claim 16, wherein the vehicle is a bus.

19. The method of claim 16, wherein the vehicle is a train.

20. The system of claim 8, wherein the method is performed by a portable receiver carried by the user.
